(19) United States
(12) Patent Application Publication
(10) Pub. No.: US 2003/0022962 A1
(43) Pub. Date: Jan. 30, 2003

(54) Composition for extruded pencil casings, and pencil casings and pencils made therefrom

(76) Inventors: David G. Cook, Oakville (CA); Jacob Leidner, Toronto (CA)

Correspondence Address: Jonathan H. Spadt, Ratner & Prestia, One Westlakes, Berwyn, Suite 301, P.O. Box 980, Valley Forge, PA, 19482-0980, US

(21) Appl. No.: 09/799,642

(22) Filed: Mar. 6, 2001

(51) Int. Cl. C09D 13/00; C08L 53/02

(52) U.S. Cl. 523/164; 524/14

(57) ABSTRACT

A composition for a pencil casing comprising 45-55% by weight polystyrene polymer or copolymer, 35-45% by weight wood fiber, 0-6% by weight lubricant, and 4-6% by weight compatibilizing agent. A preferred compatibilizing agent is polystyrene maleic anhydride. The preferred polystyrene is acrylonitrile butadiene styrene. The preferred lubricants are selected from aluminum stearate, calcium stearate, and zinc stearate, with zinc stearate the most preferred. The invention may optionally include 0-5% by weight polyethylene terephthalate and 0-5% by weight polyethylene. Also included are a pencil casing made from the composition and a pencil made from the composition.

### FIELD OF INVENTION

This invention relates generally to pencils, and more specifically, to compositions for extruded pencil casings and pencils made therefrom.

### BACKGROUND OF INVENTION

Traditionally, pencils are a central core of writing material (i.e. lead or graphite) surrounded by a casing of wood. Sometimes, the outside surface of the wood casing is painted, thus forming a sheath on the outside of the pencil. The traditional way of manufacturing these pencils is time consuming and relatively expensive as compared to the polymeric pencils now known.

Recent pencil production technology has increasingly focused on polymeric materials and how these polymeric materials might be used in pencils. Typically, in a polymeric pencil production process, the pencil casing and its writing material are coextruded. That is to say, the writing material and the pencil casing are extruded from one die which forms both the writing material and its casing. If a sheath is also desired, this may be added as a third element and the extrusion becomes a “triple coextrusion” or “tri-extrusion” process, each component of the pencil being received in the triple coextrusion die from a different extruder. This manufacturing technology is generally well known to those skilled in the art. An example of a coextrusion process is disclosed in U.S. Pat. No. 5,531,947 to Metzger et al. U.S. Pat. Nos. 3,821,157 to Muller et al. and U.S. Pat. No. 4,371,632 to Grossman et al. disclose leads that can be extruded from polymer based systems. A pencil casing extruded from a foamable thermoplastic resin is disclosed in U.S. Pat. No. 5,360,281 to Kamen et al.

Because the casing of many conventional pencils can be coextruded with the rest of the pencil, it has become desirous to produce improved casing materials which are suitable for extrusion. Consumers, however, often prefer the pencil to appear, feel, and function more like a traditional pencil, i.e. one having wood as the casing. Typical polymeric casings, however, do not have the qualities of wood.

Several characteristics define the quality of a pencil, and include the ease with which the pencil is sharpened (sharpenability), the stiffness of the pencil, the toughness of the pencil, and the strength of the pencil. Having set the standard for those qualities traditionally deemed important, wood casings provided good sharpenability, good stiffness, good toughness, and good strength. Many of these qualities are lost with conventional polymeric casings.

Thus, there is a need for a polymeric pencil casing material that would provide good extrudability so as to be useable in known production technologies, yet exhibit appearance, feel, and functionality more like that of wood.

### SUMMARY OF INVENTION

The present invention provides a composition used for pencil casings comprising 45-55% by weight polystyrene, 35-45% by weight wood fiber, 0-6% by weight lubricant, and 4-6% by weight compatibilizing agent. The polystyrene can be either a polymer or copolymer. A preferred compatibilizing agent is polystyrene maleic anhydride. The preferred polystyrenes include crystal polystyrene, high impact polystyrene, and acrylonitrile butadiene styrene, with acrylonitrile butadiene styrene being the most preferred. The preferred extrusion lubricants are selected from aluminum stearate, calcium stearate, and zinc stearate, with zinc stearate being the most preferred. The composition may optionally include 0-5% by weight polyethylene terephthalate reinforcing fiber and 0-5% by weight polyethylene or polyethylene maleic anhydride copolymer.

Also included are pencil casings made from the composition of the present invention. A preferred composition for the pencil casing of the present invention comprises 47-51% by weight acrylonitrile butadiene styrene, 37-39% by weight wood fiber, 0-6% by weight lubricant, and 4-6% by weight polystyrene maleic anhydride. This preferred composition optionally includes 0-5% by weight polyethylene terephthalate reinforcing fiber and 0-5% by weight polyethylene maleic anhydride copolymer.

The most preferred composition according to the present invention comprises 49.5% by weight acrylonitrile butadiene styrene, 38.5% by weight wood fiber, 5% by weight zinc stearate, and 5% by weight polystyrene maleic anhydride. This most preferred composition optionally includes 2% by weight polyethylene maleic anhydride copolymer.

Also included in the present invention are pencils made from the composition. The pencils are comprised of a casing made with the composition of the present invention and a writing material disposed within the casing.

### DETAILED DESCRIPTION OF INVENTION

The present invention provides a composition used for pencil casings comprising 45-55% by weight polystyrene, 35-45% by weight wood fiber, 0-6% by weight lubricant, and 4-6% by weight compatibilizing agent. The polystyrene may be either a polymer or copolymer. A preferred compatibilizing agent is polystyrene maleic anhydride. The preferred polystyrenes are crystal polystyrene, high impact polystyrene, and acrylonitrile butadiene styrene, with acrylonitrile butadiene styrene being the most preferred. The preferred lubricants are selected from aluminum stearate, calcium stearate, and zinc stearate, with zinc stearate being the most preferred. The composition may optionally include 0-5% by weight polyethylene terephthalate and 0-5% by weight polyethylene. Also included are pencil casings made from this composition and pencils made from these casings.

The composition of the present invention provides several favorable characteristics for pencil casings, including good sharpenability, good stiffness, good toughness, and good strength. It is believed that by mixing a wood fiber with a polymeric material and binding them with an appropriate compatibilizing agent, the characteristics demonstrated by a wood pencil can be replicated.

Several experiments were run with differing amounts of the components of the present invention. These experiments are set forth below in the several examples. Casings extruded from the different compositions were then tested for the desired characteristics and physical properties described above.

In each example, casing component materials were dry mixed in a 10 gallon plastic pail, then transferred into a porous drying bag in a desiccating drier for drying overnight at 100° C. The dried mixture was then melt compounded using a Betol 40 mm twin screw extruder with standard high-shear mixing configuration. The extruder was operated under typical conditions, known to those skilled in the art, at temperatures ranging from 170 to 185° C. and at 120 RPM.

The compounded mixtures were subsequently profile extruded using a Brabender ¾ inch single screw extruder operated at 180 to 185° C. and at 24 RPM. The pencil casing was formed using an attached 7.9 mm diameter orifice die with a shallow inlet taper and a L/D ratio of 6:1. The profile was slowly extruded onto a polished stainless steel trough and allowed to cool slowly in ambient air. The cooled extruded profile was ultimately cut to normal pencil lengths (i.e. between about 6 and 12 inches). For purposes of most testing, and unless otherwise specified herein, the casings were solid and did not contain a lead.

Sharpenability was determined by cutting sections of the extruded casing and then sharpening them in a typical pencil sharpener. Qualitative observations were then made on the ease of sharpening according to the following scale:

| | |
|---|---|
| very poor | essentially unsharpenable; |
| poor | much torque required, small fuzzy shavings, |
| | sometimes stopped sharpening; |
| fair | higher than average torque required, small |
| | fragmented shavings made; |
| good | average torque required, rolled shavings; and |
| very good | little torque required, large continuous rolled |
| | shavings. |

The flexural strength, modulus, and percent strain at break were measured in accordance with ASTM D 790-96a, test method I, procedure A. The test was conducted using an Instron tensile tester equipped with Series IX, Version 5.01 software. The test was conducted at 23° C. and 50% relative humidity.

As a measure of toughness, the impact resistance of the casings was measured. An analysis of the results of impact tests allowed a relative comparison produced during development of the present invention. The impact resistance was measured using an Izod tester equipped with a 2 pound weight. The test was conducted at 23° C. and 50% relative humidity. Essentially, the weight, attached to a pendulum, is swung, striking the stationary unnotched casing sample, breaking the casing, and the pendulum's remaining energy is measured. The difference between the original and final pendulum potential energy allows calculation of impact in impact in ft-lb of energy, a value which can be used to compare toughness between different casings. The higher the difference the tougher the pencil.

The following examples reflect experiments performed to determine a combination of components which would best produce a casing that would demonstrate the qualities of wood.

### EXAMPLE 1

| Component | Weight % of Component |
|---|---|
| Acrylonitrile butadiene styrene copolymer | 49.5 |
| Wood fiber | 38.5 |
| Zinc stearate | 5.0 |
| Polystyrene maleic anhydride copolymer | 5.0 |
| Polyethylene maleic anhydride copolymer | 2.0 |

### EXAMPLE 2

| Component | Weight % of Component |
|---|---|
| Acrylonitrile butadiene styrene copolymer | 47.6 |
| Wood fiber | 37.4 |
| Zinc stearate | 5.0 |
| Polystyrene maleic anhydride copolymer | 5.0 |
| Polyethylene terephthalate fiber | 5.0 |

### EXAMPLE 3

| Component | Weight % of Component |
|---|---|
| Acrylonitrile butadiene styrene copolymer | 50.8 |
| Wood fiber | 38.2 |
| Zinc stearate | 5.0 |
| Polystyrene maleic anhydride copolymer | 5.0 |
| Polyethylene maleic anhydride copolymer | 1.0 |

The acrylonitrile butadiene styrene used for experimental purposes was a Magnum 9555 grade produced by Dow Chemical Company. Other acrylonitrile butadiene styrenes could, of course, be used. In addition, other polystyrene compounds work. Crystal polystyrene, such as that sold by Dow Chemical Company would work, particularly the 615APR grade. Dow Chemical Company's high impact polystyrene sold as 425-27 Nat would also work, among other suitable polystyrenes, including general purpose grade polystyrenes.

The polystyrene maleic anhydride copolymer acts as a compatibilizing agent for the polystyrene and the wood fiber to increase the strength of the composite. By compatibilizing, it is meant that the polystyrene maleic anhydride bonds to both the wood fiber and the acrylonitrile butadiene styrene, thereby acting as a binder within the system. The maleic anhydride constituents along the polystyrene chain bond to the cellulosic fibers of the wood filler which effectively forms a polymeric coating on the wood filler. This polymeric coating on the cellulosic fibers is then available to bond to the acrylonitrile butadiene styrene component of the system thus forming a wood/polymer union. This compatibilizing role of the polystyrene maleic anhydride is thus important in the overall performance of the casing material.

Examples of polystyrene maleic anhydrides suitable for use in the present invention are produced by Elf Atochem and are sold as SMA 2000 and SMA 3000. SMA 2000 has a reported molecular weight of 1,700 and a polystyrene to maleic anhydride ratio of 2:1. SMA 3000 has a reported molecular weight of 1,900 and a polystyrene to maleic anhydride ratio of 3:1. Other suitable styrene maleic anhydrides, and other suitable maleic anhydrides utilizing different polymeric backbones, would also work.

The addition of polyethylene tends to improve sharpenability but will lower stiffness and toughness for the composition. Thus, its introduction must be carefully considered so as to optimize these two competing but mutually desired characteristics. If the stiffness and toughness of the casing is to be retained the polyethylene phase must be well bonded to the composition. A graft polymer of polyethylene-maleic anhydride, such as the polyethylene-maleic anhydride graft copolymer marketed by DuPont under the name Fusabond 158D, is suitable for this purpose. It is believed that the polyethylene-maleic anhydride bonds to the styrene-maleic anhydride polymer (which in turn bonds to the styrene polymer or copolymer component) and to the wood fiber components in the casing composition. It is believed that the compatibilizing agent acts to cause an increase in both the strength and stiffness of the resultant composition which makes it particularly well suited as a component of a pencil casing.

Another additional material is polyethylene terephthalate (PET). The PET is added as a fiber reinforcer to increase the toughness of the composition. Too much PET can, however, lead to a reduction in sharpenability as the material will not want to “peel” away from the casing during the sharpening process.

The wood fiber can be of a number of different types. The fibers used in the experiments disclosed herein are from American Wood Fibers of Schofield, Wis. These fibers were both hardwood and softwood flour and ranged from 40 to 60 mesh (mesh number referring to the material that will pass through a given mesh size). Other suitable fibers could, of course, be used.

Table 1 sets forth the test results for the different physical properties set forth above.

TABLE 1

| | Sharpen- | Density | Strength at | Modulus | Strain at | Impact |
|---|---|---|---|---|---|---|
| EXAMPLE | ability | (g/cc) | Break (psi) | (psi) | Break (%) | (ft-lb) |
| 1 | Very Good | 1.16 | 7,514 | 745,400 | 1.37 | 0.129 |
| 2 | Good | 1.17 | 8,680 | 772,000 | 1.51 | 0.147 |
| 3 | Fair | 1.13 | 8,310 | 721,000 | 1.65 | 0.152 |

A pencil casing extruded with the composition of Example 1 (the preferred embodiment) was prepared for comparison to a wood pencil and a typical Crayola® pencil. (Crayola is a registered trademark of Binney & Smith, Inc.) A typical Crayola pencil casing is comprised of natural wood, namely wood from the tropical pine tree. The prepared casing had a diameter of 7.3 mm and a core hole of 3.35 mm to accept a typical 3.3 mm lead. In this case, a lead was inserted, unlike the solid casings which were used to generate the data in Table 1. The casings were 7.5 inches in length and a solution of 30% polystyrene and 70% xylene was used to glue the leads into the casings. The glued pencils were dried in an oven at 45° C. for 1 hour. These pencils were then analyzed for the physical properties set forth above. The data from the pencils according to the present invention is set forth below in Table 2, along with the data for a cedar wood pencil and a typical Crayola pencil.

TABLE 2

| | Sharpen- | Diameter | Strength at | Modulus | Strain at | Impact |
|---|---|---|---|---|---|---|
| PENCIL | ability | (mm) | Break (psi) | (psi) | Break (%) | (ft-lb) |
| TYPICAL | Very good | 7.12 | 14,590 | 1,259,000 | 1.72 | 0.426 |
| CRAYOLA ® | | | | | | |
| PENCIL | | | | | | |
| CEDAR WOOD | Very good | 5.0 | 10,520 | 1,090,000 | 1.85 | 0.251 |
| MADE WITH | Very good | 7.50 | 5,959 | 589,500 | 1.43 | 0.121 |
| COMPOSTION | | | | | | |
| ACCORDING to | | | | | | |
| EXAMPLE 1 | | | | | | |

As can be seen through an examination of the data presented in Table 2, although differing from the Crayola® pencil and a typical wood pencil, the polymeric pencil demonstrates the characteristics deemed important. Thus, the compositions of the present invention provide a wood-like casing for use in extruded pencils.

Although the present invention has been particularly described in conjunction with specific preferred embodiments, it is evident that many alternatives, modifications, and variations will be apparent to those skilled in the art. It is therefore contemplated that the appended claims will embrace any such alternatives, modifications, and variations as falling within the true scope and spirit of the present invention.

1. A composition used for pencil casings comprising:
45-55% by weight polystyrene polymer or copolymer;
35-45% by weight wood fiber;
0-6% by weight lubricant; and
4-6% by weight compatibilizing agent.

2. The composition of claim 1 wherein said compatibilizing agent is polystyrene maleic anhydride copolymer.

3. The composition of claim 1 wherein said compatibilizing agent is polyethylene maleic anhydride.

4. The composition of claim 1 wherein said polystyrene is selected from the group consisting of crystal polystyrene, high impact polystyrene, and acrylonitrile butadiene styrene.

5. The composition of claim 1 wherein said polystyrene is acrylonitrile butadiene styrene.

6. The composition of claim 1 wherein said lubricant is selected from the group consisting of aluminum stearate, calcium stearate, and zinc stearate.

7. The composition of claim 1 wherein said lubricant is zinc stearate.

8. The composition of claim 1, further comprising 0-5% by weight polyethylene terephthalate.

9. The composition of claim 1, further comprising 0-5% by weight polyethylene.

10. A pencil casing comprising:
45-55% by weight polystyrene polymer or copolymer;
35-45% by weight wood fiber;
0-6% by weight lubricant; and
4-6% by weight polystyrene maleic anhydride.

11. The pencil casing of claim 10 comprising:
47-51% by weight polystyrene polymer or copolymer;
37-39% by weight wood fiber;
0-6% by weight lubricant; and
4-6% by weight polystyrene maleic anhydride.

12. The pencil casing of claim 10 wherein said polystyrene is selected from the group consisting of crystal polystyrene, high impact polystyrene, and acrylonitrile butadiene styrene.

13. The pencil casing of claim 10 wherein said polystyrene is acrylonitrile butadiene styrene.

14. The pencil casing of claim 10 wherein said lubricant is selected from the group consisting of aluminum stearate, calcium stearate, and zinc stearate.

15. The pencil casing of claim 10 wherein said lubricant is zinc stearate.

16. The pencil casing of claim 10, further comprising 0-5% by weight polyethylene terephthalate.

17. The pencil casing of claim 10, further comprising 0-5% by weight polyethylene.

18. A pencil casing comprising:
49.5% by weight acrylonitrile butadiene styrene;
38.5% by weight wood fiber;
5% by weight zinc stearate;
5% by weight polystyrene maleic anhydride; and
2% by weight polyethylene maleic anhydride graft copolymer.

19. A pencil comprising:
a casing comprised of:
45-55% by weight polystyrene polymer or copolymer;
35-45% by weight wood fiber;
0-6% by weight lubricant; and
4-6% by weight polystyrene maleic anhydride; and
a writing material disposed within said casing.

20. The pencil of claim 19 wherein said casing comprises:
47-51% by weight polystyrene polymer or copolymer;
37-39% by weight wood fiber;
0-6% by weight lubricant; and
4-6% by weight polystyrene maleic anhydride.

21. The pencil of claim 19 wherein said polystyrene is selected from the group consisting of crystal polystyrene, high impact polystyrene, and acrylonitrile butadiene styrene.

22. The pencil of claim 19 wherein said polystyrene is acrylonitrile butadiene styrene.

23. The pencil of claim 19 wherein said lubricant is selected from the group consisting of aluminum stearate, calcium stearate, and zinc stearate.

24. The pencil of claim 19 wherein said lubricant is zinc stearate.

25. The pencil of claim 19 wherein said casing further comprises
0-5% by weight polyethylene terephthalate.

26. The pencil of claim 19 wherein said casing further comprises
0-5% by weight polyethylene.
